(19) United States
(12) Patent Application Publication
(10) Pub. No.: US 2016/0293295 A1
(43) Pub. Date: Oct. 6, 2016

(54) SHIELDED CABLE

(71) Applicant: Hitachi Metals, Ltd., Tokyo (JP)

(72) Inventors: Detian HUANG, Hitachi (JP); Takanobu WATANABE, Hitachi (JP); Norihito NISHIURA, Hitachi (JP)

(21) Appl. No.: 14/967,049

(22) Filed: Dec. 11, 2015

(30) Foreign Application Priority Data
Mar. 31, 2015 (JP) 2015-072835

(51) Int. Cl. H01B 11/18; H01B 7/02; H01B 1/02

(52) U.S. Cl. CPC H01B 11/1895; H01B 1/026; H01B 7/0241; H01B 7/0216

(57) ABSTRACT

A shielded cable includes a signal wire, a braided shield disposed around the signal wire, a shielding tape wound around the braided shield, and a jacket disposed around the shielding tape. The shielding tape includes a tape substrate, a magnetic hot-melt adhesive layer that is disposed on an outer surface of the tape substrate and that is made of a magnetic resin composite including a magnetic powder and a hot-melt adhesive, and an electroconductive metal layer that is disposed on an inner surface of the tape substrate and that is made of an electroconductive metal. The magnetic hot-melt adhesive layer is in close contact with the jacket, and the electroconductive metal layer is in contact with the braided shield.

The present application is based on Japanese patent application No. 2015-072835 filed on Mar. 31, 2015, the entire contents of which are incorporated herein by reference.

### BACKGROUND OF THE INVENTION

1. Field of the Invention

The present invention relates to a shielded cable that can reduce both the effects of an external magnetic field and an external electromagnetic wave, which are causes of external noise.

2. Description of the Related Art

In exiting shielded cables, a braided shield, which is composed of a plurality of shield strands, is disposed around a signal wire. The braided shield reduces the effect of an external electromagnetic wave, which is a cause of external noise.

However, as the signal transmission speed in electronic devices and the like, which are sources of external electromagnetic waves, has increased, an external electromagnetic wave in a high-frequency range may reach the signal wire through gaps between the shield strands.

Therefore, by sealing the gaps between the shield strands by further winding a shielding tape around the braided shield, an external electromagnetic wave in a high-frequency range is prevented from reaching the signal wire through the gaps between the shield strands.

Moreover, a ferrite core is attached to an end portion or the like of the shielded cable, because it is not possible to reduce the effect of an external magnetic field, which is a cause of external noise, by using only the braided shield (see, for example, Japanese Registered Utility Model No. 3172343).

### SUMMARY OF THE INVENTION

However, when a ferrite core, which has no flexibility, is attached to an end portion or the like of a shielded cable, the flexibility and the elasticity of the end portion or the like of the shielded cable is impaired. Accordingly, for example, the shielded cable may easily break at an end of the ferrite core, where stress concentration occurs due to bending or the like of the shielded cable.

An object of the present invention is to provide a shielded cable that can perform an electromagnetic shielding function and a magnetic shielding function while maintaining flexibility and elasticity.

To achieve the object, a shielded cable according to the present invention includes at least one signal wire, a braided shield disposed around the signal wire, a shielding tape wound around the braided shield, and a jacket disposed around the shielding tape. The shielding tape includes a tape substrate, a magnetic hot-melt adhesive layer that is disposed on an outer surface of the tape substrate and that is made of a magnetic resin composite including a magnetic powder and a hot-melt adhesive, and an electroconductive metal layer that is disposed on an inner surface of the tape substrate and that is made of an electroconductive metal. The magnetic hot-melt adhesive layer is in close contact with the jacket, and the electroconductive metal layer is in contact with the braided shield.

Preferably, the jacket is made by full extrusion coating, and the magnetic hot-melt adhesive layer is fused together with the jacket by extrusion heat.

Preferably, the magnetic powder is made of FINEMET (registered trademark), and the hot-melt adhesive is made of an olefin resin.

With the present invention, it is possible to provide a shielded cable that can perform an electromagnetic shielding function and a magnetic shielding function while maintaining flexibility and elasticity.

### BRIEF DESCRIPTION OF THE DRAWINGS

The foregoing and other exemplary purposes, aspects and advantages will be better understood from the following detailed description of the invention with reference to the drawings, in which:

FIG. 1 is a cross-sectional view of a shielded cable according to an embodiment of the present invention; and

FIG. 2 is a cross-sectional view of a shielding tape in FIG. 1.

### DESCRIPTION OF THE PREFERRED EMBODIMENTS

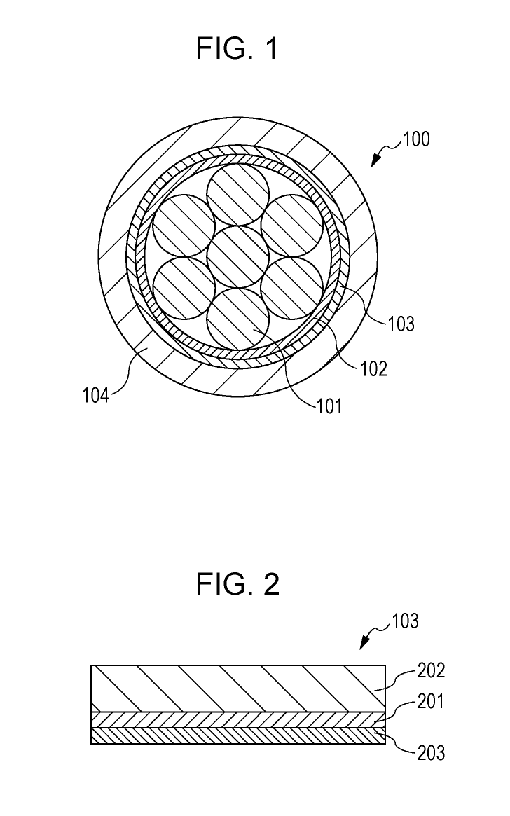

Referring now to the drawings, and more particularly to FIGS. 1-2, there are shown exemplary embodiments of the methods and structures according to the present invention.

Hereinafter, an embodiment of the present invention will be described with reference to the drawings.

As illustrated in FIG. 1, a shielded cable 100 according to the embodiment of the present invention includes at least one signal wire 101, a braided shield 102 disposed around the signal wire 101, a shielding tape 103 wound around the braided shield 102, and a jacket 104 disposed around the shielding tape 103.

The signal wire 101 is, for example, a coaxial cable. The braided shield 102 is composed of a plurality of shield strands made of a material having high electroconductivity, such as copper or a copper alloy.

As illustrated in FIG. 2, the shielding tape 103 includes a tape substrate 201, a magnetic hot-melt adhesive layer 202, and an electroconductive metal layer 203. The magnetic hot-melt adhesive layer 202 is disposed on the outer surface of the tape substrate 201 and is made of a magnetic resin composite including a magnetic powder and a hot-melt adhesive. The electroconductive metal layer 203 is disposed on the inner surface of the tape substrate 201 and is made of an electroconductive metal. The magnetic hot-melt adhesive layer 202 is in close contact with the jacket 104, and the electroconductive metal layer 203 is in contact with the braided shield 102.

The tape substrate 201 is made of a material having high mechanical strength, such as polyethylene terephthalate. The thickness of the tape substrate 201 is in the range of about 7 μm to 15 μm. This is because, if the thickness of the tape substrate 201 is less than 7 m, the mechanical strength of the shielding tape 103 is low, and therefore the shielding tape 103 may become broken when the shielding tape 103 is being around the braided shield 102; and, if the thickness of the tape substrate 201 is greater than 15 μm, the flexibility of the shielding tape 103 is low, and therefore it may be difficult to wind the shielding tape 103 around the braided shield 102.

The thickness of the magnetic hot-melt adhesive layer 202 is in the range of about 20 μm to 50 μm. This is because, if the thickness of the magnetic hot-melt adhesive layer 202 is less than 20 μm, it may be difficult to make the shielding tape 103 and the jacket 104 be sufficiently in close contact with each other; and, if the thickness of the magnetic hot-melt adhesive layer 202 is greater than 50 μm, the flexibility of the shielding tape 103 is low, and therefore it may be difficult to wind the shielding tape 103 around the braided shield 102.

The magnetic powder included in the magnetic hot-melt adhesive layer 202 is made of, for example, FINEMET (registered trademark) made by Hitachi Metals, Ltd. FINEMET (registered trademark) is a nanocrystalline soft magnetic material that has a high saturation magnetic flux density and a high magnetic permeability. Therefore, by using FINEMET (registered trademark), the shielded cable 100 can perform a high magnetic shielding function.

The magnetic hot-melt adhesive layer 202 is composed of a hot-melt adhesive that is made of, for example, an olefin resin. It is possible to reduce an environmental load by using an olefin resin, because an olefin resin does not include a halogen compound.

The electroconductive metal layer 203 is made of a material having a high electroconductivity, such as copper or a copper alloy. The thickness of the electroconductive metal layer 203 is in the range of about 7 μm to 15 μm. This is because, if the thickness of the electroconductive metal layer 203 is less than 7 μm, the shielded cable 100 might not be able to sufficiently perform an electromagnetic shielding function; and, if the thickness of the electroconductive metal layer 203 is greater than 15 μm, the flexibility of the shielding tape 103 is low, and therefore it may be difficult to wind the shielding tape 103 around the braided shield 102.

The jacket 104 is made by full extrusion coating the periphery of the shielding tape 103 with a fluorocarbon resin or the like. The magnetic hot-melt adhesive layer 202 is melted and fused together with the jacket 104 by using heat generated during full extrusion coating, so that the magnetic hot-melt adhesive layer 202 and the jacket 104 are securely and closely in contact with each other.

As described above, in the shielded cable 100, the braided shield 102 and the electroconductive metal layer 203 serve an electromagnetic shield layer, and the magnetic hot-melt adhesive layer 202 serves as a magnetic shield layer. Therefore, without attaching a ferrite core to an end portion or the like of the shielded cable, it is possible to reduce both the effects of an external magnetic field and an external electromagnetic wave, which are causes of external noise.

Preferably, the magnetic shield layer is disposed outside of the electromagnetic shield layer in order to reduce both the effects of an external magnetic field and an external electromagnetic wave, which are causes of external noise.

The shielding tape 103 is not likely to reduce the flexibility and the elasticity of the shielded cable 100. Therefore, by using the shielding tape 103, it is possible for the shielded cable 100 to perform an electromagnetic shielding function and a magnetic shielding function while maintaining flexibility and elasticity.

In the shielded cable 100, the magnetic hot-melt adhesive layer 202 is in close contact with the jacket 104 over the entire length thereof. Therefore, when, for example, the shielded cable 100 is bent, the shielding tape 103 does not become displaced and a gap is not formed. As a result, the shielded cable 100 can reliably perform an electromagnetic shielding function and a magnetic shielding function.

In the shielded cable 100, the electroconductive metal layer 203 and the braided shield 102 are in contact with each other over the entire length thereof. Therefore, by only connecting the braided shield 102 or the electroconductive metal layer 203 to a ground electrode, both the braided shield 102 and the electroconductive metal layer 203 can be easily grounded.

Accordingly, the present invention can provide a shielded cable that can perform an electromagnetic shielding function and a magnetic shielding function while maintaining flexibility and elasticity.

What is claimed is:

1. A shielded cable comprising:
at least one signal wire;
a braided shield disposed around the signal wire;
a shielding tape wound around the braided shield; and
a jacket disposed around the shielding tape;
wherein the shielding tape includes
a tape substrate,
a magnetic hot-melt adhesive layer that is disposed on an outer surface of the tape substrate and that is made of a magnetic resin composite including a magnetic powder and a hot-melt adhesive, and
an electroconductive metal layer that is disposed on an inner surface of the tape substrate and that is made of an electroconductive metal, and
wherein the magnetic hot-melt adhesive layer is in close contact with the jacket, and the electroconductive metal layer is in contact with the braided shield.

2. The shielded cable according to claim 1,
wherein the jacket is made by full extrusion coating, and
wherein the magnetic hot-melt adhesive layer is fused together with the jacket by extrusion heat.

3. The shielded cable according to claim 1,
wherein the magnetic powder is made of nanocrystalline soft magnetic material, and
wherein the hot-melt adhesive is made of an olefin resin.
